(19) United States
(12) Patent Application Publication
(10) Pub. No.: US 2013/0201907 A1
(43) Pub. Date: Aug. 8, 2013

(54) Wireless Data Distributor, Network System and Method for Receiving Audio and Video Streaming Data and Internet Website Data

(71) Applicants: Chung-Jen CHEN, New Taipei City (TW); Cheng-Ming CHEN, New Taipei City (TW); Wei-Hua CHEN, New Taipei City (TW)

(72) Inventors: Chung-Jen CHEN, New Taipei City (TW); Cheng-Ming CHEN, New Taipei City (TW); Wei-Hua CHEN, New Taipei City (TW)

(73) Assignee: AVERMEDIA TECHNOLOGIES, INC., New Taipei City (TW)

(21) Appl. No.: 13/366,476

(22) Filed: Feb. 6, 2012

(51) Int. Cl. H04W 4/00

(52) U.S. Cl. 370/328

(57) ABSTRACT

A wireless data distributor, a network system and a method for receiving A/V streaming data and Internet website data are provided. The method includes steps of receiving A/V streaming signals from a A/V streaming data source; transforming the A/V streaming signals into first wireless network packets; receiving second wireless network packets from the Internet via a network router; and selecting and sending the first or second wireless network packets to a client-end device preferentially according to priority ranks of the first and second wireless network packets.

### BACKGROUND

1. Technical Field

The present invention relates to a method for receiving data by wireless networks, and more particularly to a network system, a wireless data distributor, and a method for receiving audio/video (A/V) streaming data and Internet website data.

2. Description of Related Art

With the advance of electronic technology, a portable electronic device (e.g. a notebook computer, a tablet PC or a smart phone) can be wirelessly connected to a wireless network TV box through a wireless module (e.g. Wi-Fi module) built in a conventional wireless network TV box, so that the portable electronic device can receive TV signals from the conventional wireless network TV box for watching TV, or transmitting remote-control signals for operating the wireless network TV box.

However, while the portable electronic device is used for watching TV from the wireless network TV box, the portable electronic device cannot be used to browse external Internet websites on the Internet and download information from the Internet. The portable electronic device has to be disconnected from the wireless network TV box first and then can be connected to a wireless access point for getting into the Internet via the wireless access point.

As a result, the portable electronic device cannot be used for both watching TV from the wireless network TV box and browsing external Internet websites on the Internet within a wireless network, thus causing inconvenience and troubles, and reducing the user's utilizing desire of the wireless network TV box.

### SUMMARY

One aspect of the present invention is to provide a network system, a wireless data distributor, and a method for receiving A/V streaming data and Internet website data, so as to watch TV and browse external Internet websites on the Internet through one single network device.

The network system for receiving A/V streaming data and Internet website data comprises a network router, an A/V streaming data source and a wireless data distributor. The network router is used as a wireless access point for entering the Internet. The wireless data distributor comprises an A/V signal converting module, a processor, a wireless signal transceiving module and a task priority decision module. The A/V signal converting module is linked to the A/V streaming data source, and receives A/V streaming signals from the A/V streaming data source. The processor is electrically connected to the A/V signal converting module, and processes and converts the A/V streaming signals from the A/V signal converting module into first wireless network packets. The wireless signal transceiving module is linked to the network router and at least one client-end device, and receives second wireless network packets from the Internet via the network router. The task priority decision module is electrically connected to the processor and the wireless signal transceiving module, and determines priority ranks of both the first wireless network packets and the second wireless network packets. Further, the wireless signal transceiving module selects and sends either the first wireless network packets or the second wireless network packets to the client-end device preferentially according to the priority ranks of the first wireless network packets and the second wireless network packets.

In one embodiment of the invention, the A/V streaming data source is an A/V player device, a digital TV signal broadcasting station, a cable TV distribution station or a monitoring device.

In another embodiment of the invention, the wireless data distributor is a wireless network TV box, and the A/V signal converting module is a TV signal receiving module. The TV signal receiving module receives TV A/V streaming signals as the A/V streaming signals from one of the digital TV signal broadcasting station and the cable TV distribution station, and transforms the TV A/V streaming signals into digital signals, and the digital signals are converted into the first wireless network packets by the processor.

In the other embodiment of the invention, the task priority decision module is a quality of service module.

In still another embodiment of the invention, the wireless signal transceiving module comprises a router-bridge module, and wireless signal transceiving module of the wireless data distributor is linked to the network router by the router-bridge module.

The method for receiving A/V streaming data and Internet website data is implemented on a wireless data distributor, and the method comprises steps of A/V streaming signals are unidirectionally received from a A/V streaming data source; the A/V streaming signals are transformed into first wireless network packets; second wireless network packets are received from a network router; and either the first wireless network packets or the second wireless network packets are selected and sent to at least one client-end device preferentially according to priority ranks of the first wireless network packets and the second wireless network packets.

In one embodiment of the invention, the video and audio streaming data source is a A/V player device, a digital TV signal broadcasting station, a cable TV distribution station or a monitoring device.

To sum up, by the network system, the wireless data distributor, and the method of the present invention, while in the moment, users use client-end devices, e.g. portable device, to electrically connect to the wireless data distributor (e.g. wireless network TV box), the users can choose to watch A/V streaming data (e.g. TV signals) or browse external Internet websites so as to decrease inconveniences and troubles, and increase user's utilizing desire thereof.

### BRIEF DESCRIPTION OF THE DRAWINGS

The present invention will be apparent to those skilled in the art by reading the following detailed description of a preferred embodiment thereof, with reference to the attached drawings, in which:

FIG. 1 is a block diagram showing a network system for receiving A/V streaming data and Internet website data according to one embodiment of the present invention;

FIG. 2 is a flow chart showing a method for receiving A/V streaming data and Internet website data according to one embodiment of the present invention;

FIG. 3 is a detailed block diagram showing a wireless data distributor for receiving A/V streaming data and Internet website data according to one embodiment of the present invention;

FIG. 4 is a detailed block diagram showing the wireless data distributor as a wireless network TV box according to one embodiment of the present invention;

FIG. 5 is a flow chart showing a method of transmitting TV signals by the wireless network TV box of FIG. 4; and

FIG. 6 is a flow chart showing a method of transmitting information of external Internet websites by the wireless network TV box of FIG. 4.

### DESCRIPTION OF THE PREFERRED EMBODIMENTS

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

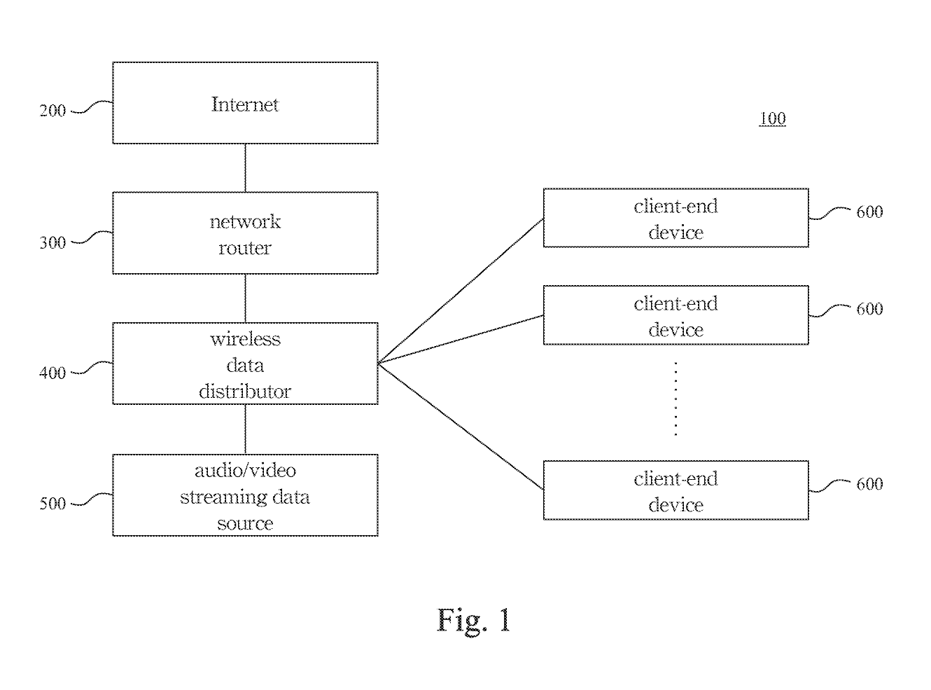

Reference will now be made to FIG. 1 which is a block diagram showing a network system 100 for receiving audio/video (A/V) streaming data and Internet website data according to one embodiment of the present invention.

The present invention provides a network system 100 for receiving A/V streaming data and Internet website data. The network system 100 comprises a network router 300, an A/V streaming data source 500, a wireless data distributor 400 and one or more client-end devices 600. The wireless data distributor 400 is linked to the network router 300, the A/V streaming data source 500 and the client-end devices 600.

In practice, the wireless data distributor 400 can be linked to the network router 300 and the client-end devices 600 through a wireless connection manner, and can be linked to the A/V streaming data source 500 through a wire or wireless connection manner.

Thus, the wireless data distributor 400 can obtain A/V streaming data from the A/V streaming data source 500, and transmit the A/V streaming data to the client-end devices 600; or the client-end devices 600 can exchange information with external Internet websites through the network router 300.

The wireless data distributor 400, for example, can be presented as a router, a wireless provider for providing A/V contents, a data packet transmitter or a hybrid of a router, a wireless provider of A/V contents and a data packet transmitter. Specifically, the network router 300 (also referred to as path router) is a computer network equipment capable of transmitting data packets to a destination through one or more networks. The network router 300 is linked to the Internet 200, that is, the network router 300 is acted as an access point of the wireless data distributor 400 in the network system 100 for accessing the Internet 200. In the embodiment, the network router 300 is not limited to wiredly or wirelessly connect to the Internet 200.

However, the network router 300 is not limited to directly accessing the Internet 200 or indirectly accessing the Internet 200 by other routers. Furthermore, since the client-end devices 600 are linked to the network router 300 through the wireless data distributor 400, the client-end devices 600 cannot be linked to the network router 300 directly.

The A/V streaming data source 500 generally refers to any content source providing massive video and audio streaming data, such as a video and audio player device, a network playback device, a digital TV signal broadcasting station, a cable TV distribution station or a monitoring device.

Specifically, the wireless data distributor 400 can be wiredly linked to the network playback device, the A/V player device, the digital TV signal broadcasting station, the cable TV distribution station or the monitoring device through cable wires; or the wireless data distributor 400 can be wirelessly linked to the A/V player device, the digital TV signal broadcasting station, the cable TV distribution station or the monitoring device through a wireless transceiving unit (such as an antenna). The A/V player device, for example, can be a CD player device, a DVD player device or Blu-Ray DVD player device, etc. Digital TV signals from the digital TV signal broadcasting station can be classified into a digital video broadcasting television (DVB-T) format, an advanced television system committee (ATSC) format and an integrated services digital broadcasting (ISDB) format, etc. The monitoring device generally refers to any device with camera module therein, such as digital camera devices, surveillance camera devices or smart phones.

Each of the client-end devices 600 generally refers to any electronic device with a wireless LAN module, such as a notebook computer, a desktop computer, a tablet PC, a smart phone or a handheld typed video game device, so that the client-end devices 600 can be wirelessly connected to the wireless data distributor 400 with the wireless LAN module.

The data signals exchanged between the wireless data distributor 400 and the client-end devices 600, and between the wireless data distributor 400 and network router 300 comply with a wireless transmission format of Wireless Fidelity (Wi-Fi), Worldwide Interoperability for Microwave Access (WiMAX) or IEEE 802.11a,b, g, n, 802.16a or e.

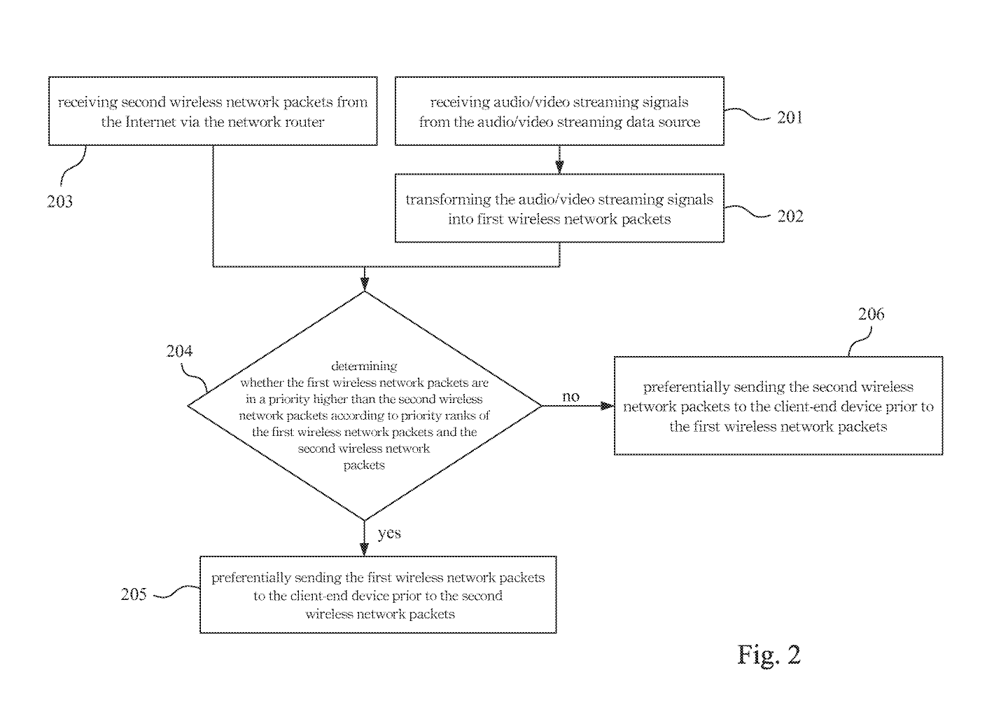

FIG. 2 is a flow chart showing a method for receiving A/V streaming data and Internet website data according to one embodiment of the present invention.

In the embodiment of the invention, the method for receiving A/V streaming data and Internet website data processes steps are outlined in the below.

First, in Step (201), one or more A/V streaming signals are received from the A/V streaming data source 500, and then Step (202) is performed.

In step (201), the wireless data distributor 400 unidirectionally receives a plurality of A/V streaming signals which are analog signals from the A/V streaming data source 500.

Next, in Step (202), the A/V streaming signals are transformed into first wireless network packets, and then Step (204) is performed.

In step (202), in order to enable the A/V streaming signals to be transmitted to one of the client-end devices 600, the wireless data distributor 400 transforms the A/V streaming signals into first wireless network packets, so that the first wireless network packets can be wirelessly delivered to the client-end device 600 via wireless networks.

On the other hand, in Step (203), second wireless network packets are received from the Internet via the network router, and then Step (204) is performed.

In step (203), in order to receive the A/V streaming signals and information from external Internet websites (including browsing the external Internet websites and downloading information from the external Internet websites), the wireless data distributor 400 receives the second wireless network packets of external Internet websites via the network router 300. Similarly, the wireless data distributor 400 also delivers another wireless network packets to the external Internet websites on the Internet 200, so that information can be exchanged between anyone of the client-end devices 600 and the external Internet websites via the network router 300.

It is noted that the foregoing Step (201) and Step (203) may or may not performed together.

Next, Step (204) is performed, according to a priority rank of the first wireless network packets and a priority rank of the second wireless network packets, for determining whether the first wireless network packets are in a priority rank higher than the second wireless network packets are, If yes, Step (205) is performed, otherwise, Step (206) is performed.

In Step (204), the priority rank of the first wireless network packets or the second wireless network packets is determined in accordance with a behavior of the client-end device 600. In other words, when the client-end device 600 desires to receive A/V streaming signals, a priority rank of the first wireless network packets is set higher than that of the second wireless network packets; on the contrary, when the client-end device 600 desires to receive information of external Internet websites on the Internet 200, a priority rank of the second wireless network packets is set higher than that of the first wireless network packets.

Next, in Step (205), the first wireless network packets are selected to be sent preferentially to the client-end device 600 prior to the second wireless network packets.

In Step (205), Since the priority rank of the first wireless network packets is set higher than the priority rank of the second wireless network packets, the wireless data distributor 400 thus decides to preferentially send the first wireless network packets to the client-end device 600 so as to prevent from interrupting the client-end device 600 for receiving A/V streaming signals.

On the other hand, in Step (206), the second wireless network packets are decided to be sent preferentially to the client-end device 600 prior to the first wireless network packets.

In Step (206), when the client-end device 600 desires to receive information of external Internet websites on the Internet 200 (including browsing the external Internet websites and downloading information from the external Internet websites), the priority rank of the second wireless network packets is set higher priority than the priority rank of the first wireless network packets, and thus, the wireless data distributor 400 is decided to send the second wireless network packets preferentially to the client-end device 600 so as to stabilize the client-end device 600 for receiving information of external Internet websites on the Internet 200.

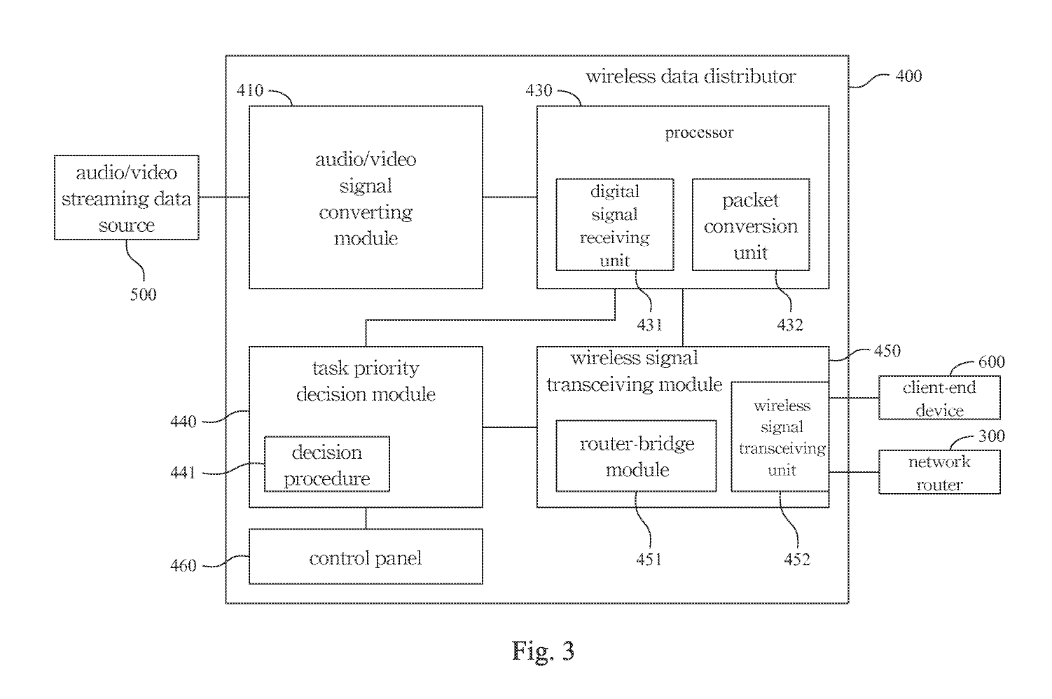

FIG. 3 is a detailed block diagram showing a wireless data distributor 400 for receiving A/V streaming data and Internet website data according to one embodiment of the present invention. In one embodiment, the wireless data distributor 400 comprises an A/V signal converting module 410, a processor 430, a task priority decision module 440 and a wireless signal transceiving module 450. The A/V signal converting module 410 is linked to the A/V streaming data source 500 and is electrically connected to the processor 430.

When the A/V streaming data source 500 is an A/V player device or a monitoring device, and the A/V streaming data source 500 transmits A/V streaming analog signals. The A/V signal converting module 410, for example, can be a A/D converter, and receives the A/V streaming analog signals from the A/V streaming data source 500, converts the A/V streaming analog signals into digital signals, and transmits the digital signals to the processor 430. The processor 430 comprises a digital signal receiving unit 431 and a packet conversion unit 432. The digital signal receiving unit 431 processes the digital signals and converts the digital signals into digital data. The packet conversion unit 431 then converts the digital data into first wireless network packets.

The task priority decision module 440 is electrically connected to the processor 430 and the wireless signal transceiving module 450, and determined priority ranks of the first wireless network packets and the second wireless network packets. The task priority decision module 440 is a Quality of Service (QoS) module which can sort data (i.e. the first wireless network packets and the second wireless network packets) according to their priority ranks so as to forward them to the client-end device 600 sequentially.

In the embodiment, the task priority decision module 440 is further provided with a decision procedure 441 which is amendable in property and built in the task priority decision module 440. When the client-end device 600 is selected to receive A/V streaming signals from the A/V streaming data source 500 using an application program of the client-end device 600 or a control panel 460 of the wireless data distributor 400, the priority rank of the first wireless network packets is set higher than the priority rank of the second wireless network v, and the set of the priority rank of the first wireless network packets is recorded in the decision procedure 441; on the other hand, when the client-end device 600 is selected to receive information of external Internet websites on the Internet 200, the priority rank of the second wireless network packets is set higher than the priority rank of the first wireless network packets, and the set of the priority rank of the second wireless network packets is recorded in the decision procedure 441. The wireless signal transceiving module 450 is wirelessly connected to the network router 300 and the client-end devices 600 through a wireless signal transceiving unit 452. Therefore, the wireless signal transceiving module 450 can transmit the first wireless network packets to one of the client-end devices 600 through the wireless signal transceiving unit 452 for providing A/V streaming signals to watch. The wireless signal transceiving module 450 can receive the second wireless network packets from the external Internet websites on the Internet 200 via the network router 300 through the wireless signal transceiving unit 452, or the wireless signal transceiving module 450 can transmit another wireless network packets to the external Internet websites via the network router 300 through the wireless signal transceiving unit 452 for providing to exchange formation between the external Internet websites and the client-end devices 600 via the network router 300.

However, the wireless signal transceiving module 450 determines to send either the first wireless network packets or the second wireless network packets to the client-end device preferentially according to the priority ranks of the first wireless network packets and the second wireless network packets, so as to avoid interrupting the client-end device 600 for receiving A/V streaming signals. Furthermore, the wireless signal transceiving module 450 can identify the first wireless network packets or the second wireless network packets based on where the first wireless network packets and the second wireless network packets come from.

Also, the wireless signal transceiving module 450 comprises a router-bridge module 451 (also refers to AP-Client Bridge module), and wireless signal transceiving module of the wireless data distributor is linked to the network router by the router-bridge module 451. The wireless signal transceiving module 450 of the wireless data distributor 400 is wirelessly connected to the network router 300 through the router-bridge module 451 so as to access the external Internet websites on the Internet via the network router 300, or a local area network of the network router 300 via the network router 300.

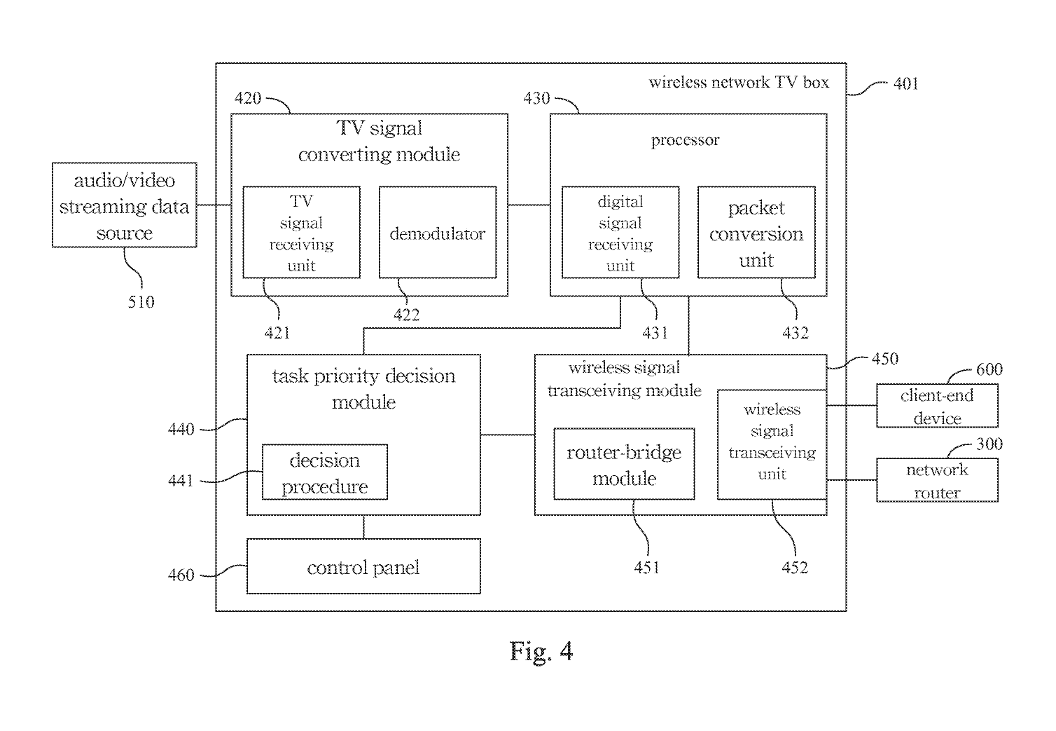

FIG. 4 is a detailed block diagram showing the wireless data distributor 400 as a wireless network TV box 401 according to one embodiment of the present invention.

In another embodiment of the wireless data distributor 400, when the A/V streaming data source 510 is referred to be a digital TV signal broadcasting station or a cable TV distribution station for issuing TV signals, the wireless data distributor 400 can be a wireless network TV box 401, and the fore-mentioned A/V signal converting module 410 can be a TV signal receiving module 420. The TV signal receiving module 420 includes a TV signal receiving unit (e.g. analog/digital tuner) and a demodulator 422 linked to the TV signal receiving unit 421.

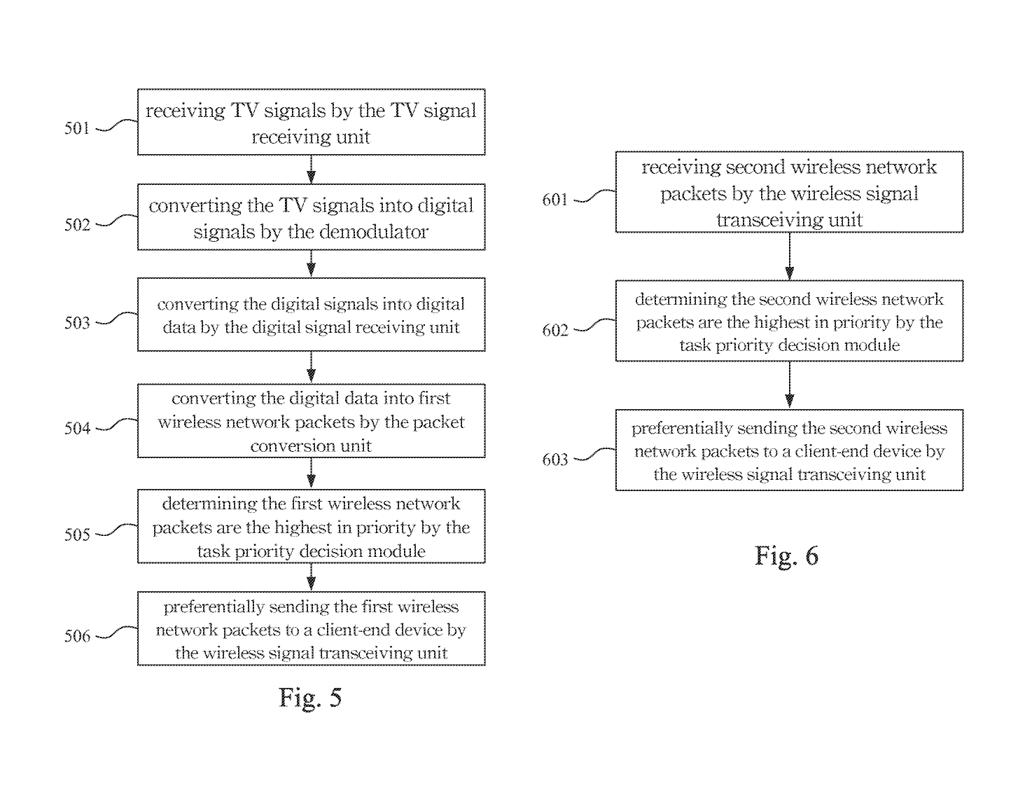

FIG. 5 is a flow chart showing a method of transmitting TV signals by the wireless network TV box 401 of FIG. 4.

When the client-end device 600 desires to watch TV, the wireless network TV box 401 transmits TV signals according to the following steps.

In Step (501), TV signals are received by the TV signal receiving unit 421, and then step (502) is performed.

For example, in Step (501), the TV signal receiving unit 421 receives A/V streaming signals of digital TV from the digital TV signal broadcasting station by a digital TV antenna (not shown). For another example, in Step (501), the TV signal receiving unit 421 receives A/V streaming signals of analog TV from the cable TV distribution station by a cable wire (not shown).

In Step (502), the demodulator 422 converts the TV signals into digital signals, and then step (503) is performed.

Specifically, the demodulator 422 demodulates the A/V streaming signals which are digital or analog TV signals, and converts the A/V streaming signals into digital signals, and the demodulator 422 transmits the digital signals to the processor 430.

In Step (503), the digital signal receiving unit 431 converts the digital signals into digital data, and then step (504) is performed.

For example, the packet conversion unit 432 decodes or decompresses the digital signals to become the digital data (e.g. mpeg 4).

In Step (504), the packet conversion unit 432 converts the digital data into first wireless network packets, and then step (505) is performed.

For example, the packet conversion unit 432 decapsulates the digital data into plural first wireless network packets so as to comply with the aforementioned wireless transmission formats.

In Step (505), once the task priority decision module 440 determines that the priority rank of the first wireless network packets is the highest or at least higher than that of the second wireless network packets, and step(506) is performed.

When the client-end device 600 desires to watch TV, the task priority decision module 440 thus determines that the priority rank of the first wireless network packets is higher than the priority rank of the second wireless network packets.

In Step (506), the wireless signal transceiving unit 452 sends the first wireless network packets to the client-end device 600 preferentially so as to allow the client-end device 600 to watch TV.

Furthermore, the client-end device 600 also can pass a control signal (e.g. channel-switching signals) to the TV signal receiving unit 421 via the wireless signal transceiving unit 452 by using an application program of the client-end device 600 or the control panel 460 of the wireless data distributor 400, so as to control the wireless network TV box 401.

FIG. 6 is a flow chart showing a method of transmitting information of external Internet websites by the wireless network TV box 401 of FIG. 4. When the client-end device 600 desires to access to the Internet 200, the wireless network TV box 401 transmits information of the external Internet websites on the Internet 200 to the client-end device 600 according to the following steps.

In Step (601), second wireless network packets from the external Internet websites on the Internet 200 are received by the wireless signal transceiving unit 452, and then step (602) is performed.

In Step (602), once the task priority decision module 440 determines that the priority rank of the second wireless network packets is the highest in high priority, step (603) is performed.

In Step (603), the wireless signal transceiving unit 452 transmits the second wireless network packets to the client-end device 600 preferentially.

On the other hand, when the wireless network TV box 401 uploads information to the external Internet websites on the Internet 200, the wireless network TV box 401 transmits uploaded information to the external Internet websites on the Internet 200 from the client-end device 600 in reverse order of the step (601)-step (603). At first, wireless network packets are uploaded from the client-end device 600 to the wireless signal transceiving unit 452 of the wireless network TV box 401, and then, since the priority rank of the second wireless network packets is determined to be higher by the task priority decision module 440, the uploaded wireless network packets also can be preferentially transmitted to the external Internet websites on the Internet 200.

To sum up, by using the network system 100, the wireless data distributor 400, and the method of the present invention, while the user uses client-end devices 600 (such as a portable device) to link to the wireless data distributor 400 (such as the wireless network TV box 401), the user may select watching A/V streaming data (e.g. TV signals) or browsing external Internet websites of Internet, thus decreasing inconvenience and troubles, and greatly promoting desires of use.

Although the present invention has been described with reference to the preferred embodiments thereof, it is apparent to those skilled in the art that a variety of modifications and changes may be made without departing from the scope of the present invention which is intended to be defined by the appended claims.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

What is claimed is:

1. A network system for receiving audio/video (A/V) streaming data and Internet website data, the network system comprising:
a network router used as a wireless access point for entering the Internet;
an A/V streaming data source; and
a wireless data distributor, comprising:
an A/V signal converting module linked to the A/V streaming data source for receiving A/V streaming signals from the A/V streaming data source;
a processor for processing and converting the A/V streaming signals from the A/V signal converting module into first wireless network packets;
a wireless signal transceiving module linked to the network router and at least one client-end device for receiving second wireless network packets from the Internet via the network router; and
a task priority decision module electrically connected to the processor and the wireless signal transceiving module for determining priority ranks of both the first wireless network packets and the second wireless network packets,
wherein the wireless signal transceiving module selects and sends the first wireless network packets or the second wireless network packets to the at least one client-end device preferentially according to the priority ranks of the first wireless network packets and the second wireless network packets.

2. The network system according to claim 1, wherein the A/V streaming data source is an A/V player device, a digital TV signal broadcasting station, a cable TV distribution station or a monitoring device.

3. The network system according to claim 2, wherein the wireless data distributor is a wireless network TV box, and the A/V signal converting module is a TV signal receiving module,
wherein the TV signal receiving module receives TV A/V streaming signals from one of the digital TV signal broadcasting station and the cable TV distribution station, and transforms the TV A/V streaming signals into digital signals, and the digital signals are converted into the first wireless network packets by the processor.

4. The network system according to claim 1, wherein the task priority decision module is a Quality of Service (QoS) module.

5. The network system according to claim 1, wherein the wireless signal transceiving module comprises a router-bridge module, and wireless signal transceiving module of the wireless data distributor is linked to the network router by the router-bridge module.

6. A wireless data distributor for receiving A/V streaming data and Internet website data, the wireless data distributor comprising:
a A/V signal converting module linked to an A/V streaming data source for receiving A/V streaming signals from the A/V streaming data source;
a processor served for processing and converting the A/V streaming signals into first wireless network packets;
a wireless signal transceiving module linked to a network router and at least one client-end device for receiving second wireless network packets from the Internet via the network router; and
a task priority decision module linked to the processor and the wireless signal transceiving module for determining priority ranks of both the first wireless network packets and the second wireless network packets,
wherein the wireless signal transceiving module selects and sends the first wireless network packets or the second wireless network packets to the at least one client-end device preferentially according to the priority ranks of the first wireless network packets and the second wireless network packets.

7. The wireless data distributor according to claim 6, wherein the wireless data distributor is a wireless network TV box, and the A/V signal converting module is a TV signal receiving module, the TV signal receiving module comprises:
a TV signal receiving unit for receiving TV A/V streaming signals from the A/V streaming data source;
a tuner unit linked to the TV signal receiving element for transforming the TV A/V streaming signals into digital signals, wherein the digital signals are converted into the first wireless network packets by the processor.

8. The wireless data distributor for receiving A/V streaming data and Internet website data according to claim 6, wherein the task priority decision module is a Quality of Service (QoS) module.

9. The wireless data distributor according to claim 6, wherein the wireless signal transceiving module comprises a router-bridge module, and wireless signal transceiving module of the wireless data distributor is linked to the network router via the router-bridge module.

10. A method for receiving A/V streaming data and Internet website data, which is suitable for use in a wireless data distributor, the method comprising:
unidirectionally receiving A/V streaming signals from an A/V streaming data source;
transforming the A/V streaming signals into first wireless network packets;
receiving second wireless network packets from the Internet via a network router; and
selecting and sending the first wireless network packets or the second wireless network packets to at least one client-end device preferentially according to priority ranks of the first wireless network packets and the second wireless network packets.

11. The method according to claim 10, wherein the A/V streaming data source is a A/V player device, a digital TV signal broadcasting station, a cable TV distribution station or a monitoring device.
